(19) United States
(12) Patent Application Publication
(10) Pub. No.: US 2026/0242614 A1
(43) Pub. Date: Aug. 20, 2026

(54) FORMULATION FOR PRODUCING AN IR RADIATION-REFLECTING COATING

(71) Applicant: HeiQ RAS AG, Regensburg (DE)

(72) Inventors: Oliver ZECH, Regensburg (DE); Christian IFFELSBERGER, Regensburg (DE)

(73) Assignee: HeiQ RAS AG, Regensburg (DE)

(21) Appl. No.: 18/993,373

(22) PCT Filed: Jul. 12, 2023
(86) PCT No.: PCT/EP2023/069286

§ 371 Date: Jan. 10, 2025

(30) Foreign Application Priority Data
Jul. 13, 2022 (DE) 10 2022 117 520.0

(51) Int. Cl. C09D 5/33; C09D 5/24; C09D 7/40; C09D 7/61; C09D 133/04

(52) U.S. Cl. CPC C09D 5/004; C09D 5/24; C09D 7/61; C09D 7/67; C09D 7/70; C09D 133/04

(57) ABSTRACT

The invention relates to a formulation for preparing an IR radiation-reflecting coating. The formulation comprises at least one electrically conductive metallic nanomaterial, at least one binder and at least one solvent, the weight ratio of electrically conductive metallic nanomaterial to binder being greater than 0.005.

### CROSS-REFERENCE TO RELATED APPLICATIONS

This application claims priority from German patent application No. DE 10 2022 117 520.0 filed Jul. 13, 2022, the disclosure of which is hereby incorporated herein in its entirety by reference.

### FIELD OF THE INVENTION

The invention relates to a formulation for preparing an IR radiation-reflecting coating, a composite material with such an IR radiation-reflecting coating arranged on a substrate, and a method for preparing such a composite material.

### BACKGROUND OF THE INVENTION

Materials with a sufficiently high degree of transmittance are referred to as transparent in the visible wavelength range. The transmittance is defined as the quotient of the light intensity behind an obstacle divided by the light intensity in front of the obstacle. The transmittance therefore ranges between 0 and 1 or between 0% and 100%. The visible range of the electromagnetic spectrum spans wavelengths between 400 nm and 850 nm.

With a transmittance of 92%, plexiglass may be cited as an example of a material with very high light transmittance. Other types of glass have lower transmittances, for example thermal insulation glass with a transmittance of 73% to 80%. In comparison, heavily tinted sunglasses have a transmittance of around 18%.

There are three ranges of infrared radiation, namely near IR from 690 nm to 3.0 μm, middle IR from 3.0 μm to 50 μm, and far IR in the wavelength range from 50 μm to 1 mm. Electromagnetic radiation in the middle IR is called thermal radiation.

Coatings that reflect thermal radiation are known from the prior art and are used in many applications. Such coatings are often referred to as “cool coatings” or Low Emissivity (“Low E”) coatings.

Cool coatings can improve the energy efficiency of buildings and other objects by reducing the absorption of thermal energy introduced by solar radiation. For this purpose, these layers must have high reflectivity in the near IR range and high thermal emissivity in order to release the absorbed thermal energy from solar radiation back into the environment.

From WO 2020/069183 A1, for example, compositions and processes for the use of anhydrous tricalcium phosphate as a multifunctional additive for coatings, such as paint systems, are known for improved solar reflection and heat emission properties. WO 2022/212376 A1 describes a coating solution that can be sprayed onto substrates and which reflects in the UV, visible and near infrared ranges. The spray coating not only provides high reflectivity across all visible wavelengths, but also high emissivity in the middle infrared range for effective surface cooling.

Because of their high emissivity, cool coatings are not suitable for “Low E” applications. In Low E applications, IR radiation is reflected to reduce heat loss and minimise heat penetration into the building through low thermal emissivity. At the same time, these coatings should be transparent to visible light. For this reason, Low E Coatings are typically applied to glass surfaces to reduce heat transfer and improve the energy efficiency of buildings.

Besides special dyes, coatings made of metal or metal oxide coatings, i.e. conductive materials, represent a possible way to reflect electromagnetic radiation. Low E applications therefore usually use metal or metal oxide layers that are vapour-deposited onto glass panes.

In modern thermal insulation glazing (e.g., double and triple glazing), the volume between the glass panes is filled with gas; previously, air was used, but now argon is favoured most often. The side of the pane of effective thermal insulation glazing facing the gas side is/are provided with (a) thin, transparent, heat-reflecting layer(s). This or these layers are usually sputtered on and have very good heat reflection properties. The pane can also be cleaned and wiped without these properties being lost, because the layer is protected from mechanical influences due to its positioning on the side facing the gas. The very thin sputtered coatings are vulnerable to damage by mechanical influences and cleaning.

Such thermal insulation can only be retrofitted in existing buildings by completely replacing the windows, as subsequent sputtering of an already installed window can only be done on the surfaces thereof that face away from the gas, which means that the sputtered layer is subsequently not protected against external influences.

The use of pigments such as graphite, silver leaf or gold leaf, to produce heat-reflecting layers is also known. Such layers serve as insulating foils or rescue blankets, for example, to reflect heat radiation emitted by the body and thus keep a person warm and/or minimise heat loss. However, this type of foil is not transparent.

Packaging materials are also made from such foils. And plastics coated with metal foils are used to reflect the heat radiated by radiators into the room. These composite materials (plastic with metal coating) are not transparent, they seal the walls and have low permeability to water vapour, which can lead to mould formation.

From DE 699 21 053 T2, a coated glass is known that can be used for installation in windows for residences and vehicles. This type of coated glass offers effective solar protection with only low emissions from the glass. The coatings contain tin oxide with various dopants, although the method for applying the coating described in DE 699 21 053 T2 is not suitable for retrofit solutions in existing glazing.

EP 1 025 057 B1 describes a thermal insulation coating that is almost totally transparent in the visible range of the electromagnetic spectrum and has only low absorption in the near IR range. The coating comprises multiple crosslinked or polymerised cholesteric IR-reflective layers.

If a binder is added in a typical concentration to such a transparent conductive layer to improve the stability of the layer, this leads to a loss of the heat-reflecting effect, especially if the transparency of the layer in the visible wavelength range is to be maintained at the same time.

Conductive layers that contain silver nanowires are transparent in the visible wavelength range and reflect thermal radiation, particularly in the range from 3 μm to 50 μm. In such cases, the proportion of reflected IR radiation depends on the silver content of the surface coating (Graubmann J. et al., “Silver nanowires: a new nanomaterial with advances for electrical, optical and IR systems” Proc. SPIE 11159, Electro-Optical and Infrared Systems: Technology and Applications XVI, 1115903 (9 Oct. 2019); doi: 10.1117/12.2532245). Greater electrical conductivity and increased IR reflection can be obtained by increasing the silver nanowire content in the coating. A percolating network is therefore required to achieve reflection properties in the wavelength range from 3 μm to 50 μm. A percolating network is formed when electrically conductive particles collect together closely enough to transport the electrical current over long distances.

However, these layers are not stable against external influences such as mechanical influences or scratching, and they can also be easily washed off with cleaning agents or water. In these systems, too, it has been found that the addition of a binder in typical concentration to improve the stability of the layer leads to a loss of conductivity and IR reflectivity, especially if transparency is to be maintained at the same time. Applying a protective layer with binder systems for transparent surfaces commonly available on the market thus leads to a loss of the heat-reflecting effect on the surface.

Given all the above, there is still a need for formulations that are suitable for coating substrates, wherein the coating has high optical transparency in the visible range and ensures good thermal insulation in the IR range by reflecting infrared radiation, in particular by reflecting radiation in the middle IR range.

### SUMMARY OF THE INVENTION

The present invention provides a formulation for producing a coating that reflects IR radiation. The formulation includes at least one electrically conductive metal nanomaterial, at least one binder and at least one solvent, the weight ratio of electrically conductive metal nanomaterial to binder being greater than 0.005.

Surprisingly, it has been found that when an electrically conductive metal nanomaterial is used in combination with a defined proportion of binder in a formulation that is used to produce a coating that reflects IR radiation, the coating obtained in this way has heat-reflecting properties, even if no surface conductivity is measurable. At the same time, optical transparency is also assured in the visible range of the electromagnetic spectrum. The formulation according to the invention can also be cured at low temperatures as low as room temperature. Moreover, a conventional protective layer does not have to be applied to the coating afterwards, and so the reduced IR-reflecting properties associated with such a protective layer are also avoided.

In the context of the present invention, the term “electrically conductive metal nanomaterial” is understood to mean electrically conductive metal nanoparticles, electrically conductive metal nanowires and electrically conductive metal nanotubes.

According to a general definition, “nanoparticles” describes particles that have a size in the range smaller than 100 nm. Thus, according to the official definition set forth in ISO TC 229,the use of the prefix “nano” distinguishes it from particles in the sub-micrometre range (>100 nm).

In the context of the present text, the term “metal nanowire” and in particular “silver nanowire” includes all materials that
consist predominantly of particles with metal and in particular metallic silver content >90% by weight,
have a “one-dimensional” geometry such as a rod or a hair, with a long axis (length) and a short axis (diameter),
have an aspect ratio (length/diameter) of at least 5, and
whose diameter is in the range between 1 nm and 1000 nm.

The term “nanotube” (nanotube=NT) as used here describes structures that have similar dimensions in the range from 1 nm to 1000 nm in at least two spatial directions and a dimension in the third spatial directions at least 5 times greater than the two other dimensions and are at least mainly hollow.

In the context of the present invention, the term “IR radiation-reflecting coating” means that the coating reflects at least 10% of the IR radiation averaged over the wavelength range in the wavelength range from 3 μm to 50 μm. In order to determine the reflected IR radiation, the IR reflection of the coating in the wavelength range from 3 μm to 50 μm is determined in wavelength increments of 5 nm, for example, the measured reflection values are added together, and the sum of the reflection values is divided by the number of measured values.

According to a preferred embodiment of the present invention, the weight ratio of electrically conductive metal nanomaterial to binder is greater than 0.01, preferably greater than 0.02, particularly preferably 0.05. It has been found that the IR-reflecting properties decrease as the binder content increases. Sufficient IR reflection has been demonstrated up to the inventive weight ratio of electrically conductive metal nanomaterial to binder of at least more than 0.005.

According to a further preferred embodiment of the present invention, the weight ratio of electrically conductive metal nanomaterial to binder is less than 2, preferably less than 1, particularly preferably less than 0.5.

The weight ratio of electrically conductive metal nanomaterial to binder is particularly preferably between 0.01 and 0.5, preferably between 0.02 and 0.2, particularly preferably between 0.05 and 0.1. It has been found that with a weight ratio of electrically conductive metal nanomaterial to binder in the ranges mentioned, there are formulations from which coatings with excellent IR-reflecting properties can be produced.

The electrically conductive metal nanomaterial is preferably electrically conductive metal nanoparticles, in particular electrically conductive silver nanoparticles, electrically conductive metal nanowires, in particular electrically conductive silver nanowires, electrically conductive metal nanotubes, in particular electrically conductive silver nanotubes.

The binder is preferably an IR-active binder, wherein the IR-active binder absorbs IR radiation in the wavelength range from 3 μm to 50 μm. An “IR-active binder” within the meaning of the present invention is present if the binder absorbs an absorption of more than 70% of the IR radiation averaged over the wavelength range from 3 μm to 50 μm at concentrations known to those skilled in the art.

According to a preferred embodiment, the electrically conductive metal nanomaterial contained in the formulation is, in particular, electrically conductive silver nanoparticles, electrically conductive silver nanowires or mixtures thereof. With the electrically conductive materials mentioned, particularly good properties of the coating produced using the formulation are achieved in terms of its IR reflectivity.

Particularly good properties with regard to the desired IR reflection are obtained when the formulation further contains electrically conductive carbon, electrically conductive carbon nanotubes, graphene, electrically conductive polymers or mixtures thereof.

The production of the metal nanoparticles, in particular silver nanoparticles, and metal nanowires, in particular silver nanowires, used as electrically conductive metal nanomaterial in the formulation for producing an IR radiation-reflecting coating is described in detail in WO 2016/166074, to which reference is made herewith, and the content thereof relating to the production of metal nanoparticles, in particular silver nanoparticles, and metal nanowires, in particular silver nanowires, is incorporated as part of the present text.

The formulation particularly preferably has one or more additives, the additives preferably being thickeners, adsorptive agents, wetting agents, fire retardants, polyvinylpyrrolidone, defoamers, film formers, chemical stabilisers, and colour pigments, wherein the colour pigments absorb predetermined proportions of the electromagnetic radiation in the wavelength range from 400 nm to 800 nm. The use of additives enables mechanical properties of the coating produced using the formulation to be adjusted and improved in targeted manner.

In contrast to the prior art, which describes formulations with metallic nanowires that are mixed with commercially available weight proportions of binder, coatings that are produced using a formulation according to the invention have IR-reflecting properties after drying.

Since the colour pigments absorb predetermined proportions of electromagnetic radiation in the wavelength range from 400 nm to 800 nm, specifically only those wavelengths are transmitted that can be used, for example, for applications in the area of interior decoration or plant growth. By adding colour pigments, besides the IR-reflecting properties of the coating, its colour may be adjusted at will. The coating produced using a formulation according to the invention may thus be transparent, partially transparent or opaque in the visible wavelength range.

UV-absorbing additives serve to protect against UV radiation and absorb predetermined proportions of the electromagnetic radiation in the wavelength range from 100 nm to 400 nm.

In principle, any type of binder system known to those skilled in the art can be used. The binder is particularly preferably a binder based on acrylates, epoxides, polyurethanes, silicones, siloxanes, polyolefins, cellulose derivatives, polythiophenes, polyanilines, perfluorinated polymers and copolymers of the polymers cited, and mixtures thereof. Binder systems are formulations with polymer, which are used to fix the metal structures created. In preferred embodiments, binder systems based on acrylates, epoxides, polyurethanes, silicones, siloxanes, polyolefins, cellulose derivatives, polythiophenes, polyanilines, perfluorinated polymers and copolymers of the polymers cited, and mixtures thereof are used. The binder systems cited show particularly good properties in terms of processability and IR-reflecting properties.

According to a particularly preferred embodiment, the electrically conductive metal nanomaterial is electrically conductive metal nanowires, in particular electrically conductive silver nanowires, where the quotient of length and diameter of the metal nanowires is greater than 5. The quotient of length and diameter of the metallic structure is also referred to as the aspect ratio. It has been found that when particles with a smaller aspect ratio are used, these particles must either have a comparatively larger diameter, or a higher concentration of metal nanoparticles in the formulation must be chosen in order to obtain the desired effectiveness in terms of IR-reflecting properties.

The present invention also comprises a composite material that includes a substrate and an IR radiation-reflecting coating arranged on the substrate, the coating being made from a formulation as specified above. The coating produced by using a formulation according to the invention improves the thermal insulation properties by reflecting electromagnetic radiation in the wavelength range from 3 μm to 50 μm and reduces the thermal emission of the substrate.

The IR-reflecting properties of the coating manifest themselves even though no electrical conductivity can be determined. One explanation for this fact is that there is no percolating network, but already discrete clusters of conductive particles, that is to say for example a large number of individual nanowires that are not directly connected, are sufficient to create IR-reflecting properties. However, IR reflection is only achieved if the proportion of electrically conductive metal nanomaterial to binder is in the ratio according to the invention. In such cases, although no electrical conductivity can be detected, IR reflection is still observed.

The IR radiation-reflecting coating of the composite material particularly preferably has an average spectral transmission of less than 30% in the wavelength range from 3 μm to 50 μm. The coating of the composite material therefore has a high reflectivity in the wavelength range from 3 μm to 50 μm. The IR radiation-reflecting coating of the composite material preferably has a reflection of more than 20%, preferably more than 30%, particularly preferably more than 40% in the wavelength range from 3 μm to 50 μm.

The composite material according to the invention may be used to reflect IR radiation in the wavelength range from 3 μm to 50 μm indoors (buildings, greenhouses, automotive, public transportation), in aerospace products (aircraft), mobility (cars), and clothing (camouflage, signature management).

Despite the use of a binder to create a coating with good mechanical stability, good surface resistances and reflection properties can be achieved with metallic nanowires without sacrificing the mechanical stability of the coating and its stability with regard to other external influences (e.g. waterlogging).

The substrate is preferably a polymer foil, a woven fabric, a knitted fabric, a textile material, glass, paper, concrete, cement, wood, plaster, plasterboard, a metal, or a plastic. The coating produced using a formulation according to the invention may therefore be applied to synthetic or natural substrates, which may have differing flexibilities.

According to preferred embodiments of the invention, the IR radiation-reflecting coating of the composite material has a layer thickness after drying of not more than 60 μm, preferably not more than 30 μm and particularly preferably not more than 15 μm. It has been found that the desired IR-reflecting properties are obtained to a sufficient extent while minimising material consumption with the layer thicknesses specified.

According to a further preferred embodiment, the coating has an average spectral transmission of at least 30% in the wavelength range from 400 nm to 800 nm. In the context of the present text, a coating that has an average transmission of at least 30% in the wavelength range from 400 nm to 800 nm is described as “transparent”.

According to further embodiments, the coating may also be a translucent or opaque coating. In principle, materials that allow light to pass through, but through which, as with frosted glass, objects arranged behind the material cannot be discerned, are referred to as translucent. However, a translucent coating can certainly have the average transmission of at least 30% in the wavelength range from 400 nm to 800 nm required for an optically transparent coating.

Particularly preferably, the coating that reflects IR radiation has no measurable electrical conductivity. In such cases, conductivity is not measurable using measurement methods known to those skilled in the art (e.g., four-point measurement device). By combining the binder with conductive metallic structures, a coating is formed in which no electrical conductivity can be measured, but an IR reflection effect still occurs.

In contrast to the prevailing opinion in the prior art, it has been found that when using metallic nanowires in a formulation for producing a coating that reflects IR radiation, a conductive network is not necessary to produce IR-reflecting properties.

The present invention further comprises a method for producing one of the composite materials described above, the method comprising the following steps:
a) providing a substrate,
b) providing one of the formulations described above,
c) applying the formulation provided in step b) to the substrate provided in step a),
d) drying the object obtained in step c) to form a composite material consisting of a substrate and an IR radiation-reflecting coating arranged on the substrate.

After drying, a layer with IR-reflecting properties forms on the substrate.

The drying in step d) preferably takes place at a temperature T<200° C., preferably T<100° C., particularly preferably T<50° C., most particularly preferably T<30° C. The coating can be dried both at room temperature and at temperatures up to 200° C. For energy efficiency reasons, the person skilled in the art will choose the lowest possible temperature at which the binder develops its binding properties and at which the layer dries within an acceptable period of time.

According to a further preferred embodiment, after step a) and before step c) the step of
pretreatment of the substrate surface is carried out by plasma pretreatment, corona pretreatment, cleaning, chemical pretreatment, or by applying a primer is carried out. In step c), the formulation provided in step b) is applied to the substrate pretreated in this way.

In some specific variants, pretreatment of the substrate is necessary, for example by plasma pretreatment or corona pretreatment, by cleaning to remove foreign substances, by chemical pretreatment, or by applying a primer. Pretreatment improves wetting and also improves adhesion of the formulation to the substrate. The person skilled in the art can choose the most favourable type of pretreatment for each individual case based on his or her specialist knowledge.

In step c), the formulation provided in step b) is preferably applied with spiral doctor blades, by screen printing, transfer printing, flow coating, spraying, or brushing. The type of application preferred in each individual case depends on the type of substrate. For example, screen printing is not possible when applying to a wall; a brush is seldom used to paint the substrate when applying to fabrics.

### BRIEF DESCRIPTION OF THE DRAWINGS

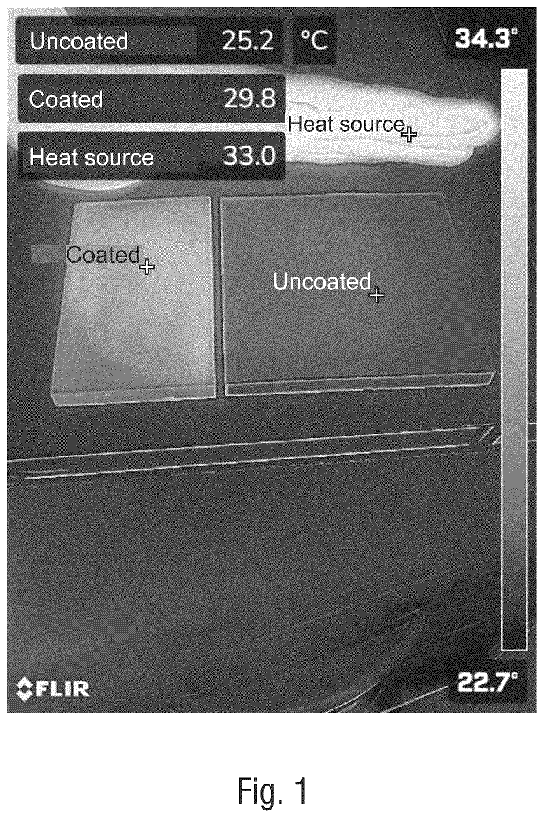

In the following text, the invention will be explained in greater detail with reference to exemplary embodiments in conjunction with FIG. 1. FIG. 1 shows a comparison of the heat reflection of an uncoated and a coated concrete test specimen.

### DETAILED DESCRIPTION OF THE INVENTION

### Example 1: Coating of a Pet Film

According to the method described in DE 10 2010 017 706 B4, silver nanowires were produced in a polyol process. From the concentrate of silver nanowires containing 4.0% by weight silver obtained in this way, aqueous and alcoholic formulations with a silver nanowire content of 0.3% by weight were prepared. For this purpose, 7.5 g silver nanowire concentrate was mixed with 74.5 g water or alcohol in a plastic screw-cap container and dispersed homogeneously by shaking. 13 g SURFLINK and 5 g of acrylate binder were then added to the dispersion. The weight ratio of silver nanowires to acrylate binder is 0.06.

SURFLINK is an additive commercially available from HeiQ RAS for the activation of Ag nanowire networks. It is a mixture of 1% by weight to 10% by weight ethanolamine and up to 2.0% by weight hydroxypropyl methylcellulose in water.

From the formulation produced in this way, wet film thicknesses of 12 μm, 24 μm and 40 μm were applied to PET films measuring approx. 10×10 cm using stainless steel doctor blades. The coated substrates were dried at 150° C. for 3 min in an oven or at room temperature for 24 h. The electrical conductivity of the coating was measured using a four-point measuring device (RCHEK 4 Point Meter, manufacturer EDTM, model #RC2175). No electrical conductivity could be detected within the measuring range of the device (1-19990 Ohm/sq.). Measurements with a commercially available infrared camera (model: Flir One Pro from Flir) show a clear reflection of IR radiation in the wavelength range from 3 μm to 50 μm.

### Example 2 (Comparison Example): Coating of a Pet Film

Silver nanowires were produced in a polyol process according to the method described in DE 10 2010 017 706 B4. From the concentrate of silver nanowires containing 4.0% by weight silver obtained in this way, aqueous and alcoholic formulations with a silver nanowire content of 0.3% by weight were prepared. For this purpose, 7.5 g silver nanowire concentrate was mixed with 14.5 g water or alcohol in a plastic screw-cap container and dispersed homogeneously by shaking. 13 g SURFLINK and 60 g acrylate binder were then added to the dispersion. The weight ratio of silver nanowires to acrylate binder is 0.005.

From the formulation produced in this way, wet film thicknesses of 12 μm, 24 μm and 40 μm were applied to PET films measuring approx. 10×10 cm using stainless steel doctor blades. The coated substrates were dried at 150° C. for 3 min in an oven or at room temperature for 24 h. The electrical conductivity of the coating was measured using a four-point measuring device (RCHEK 4 Point Meter, manufacturer EDTM, model #RC2175). No electrical conductivity could be detected within the measuring range of the device (1-19990 Ohm/sq.). Measurements with a commercially available infrared camera (model: Flir One Pro from Flir) show no increased reflection of IR radiation in the wavelength range from 3 μm to 50 μm.

### Example 3 (Comparison Example): Coating on Fabrics, Wovens, Knitted Fabrics

A formulation according to Example 2 was prepared with acrylate binder and tested qualitatively for homogeneity of the formulation. The formulation was applied directly to fabric, plastic woven and knitted fabrics. The coated substrates were dried at 150° C. for 3 min in an oven or at room temperature for 24 h.

The electrical conductivity of the coating was measured using a four-point measuring device (RCHEK 4 Point Meter, manufacturer EDTM, model #RC2175). No electrical conductivity could be detected within the measuring range of the device (1-19990 Ohm/sq.). Measurements with a commercially available infrared camera (model: Flir One Pro from Flir) show no increased reflection of IR radiation in the wavelength range from 3 μm to 50 μm.

### Example 4: Coating on Fabrics, Wovens, Knitted Fabrics

A formulation according to Example 1 with acrylate binder was prepared and tested qualitatively homogeneity of the formulation. The formulation was applied directly to fabric, plastic woven and knitted fabrics. The coated substrates were dried at 150° C. for 3 min in an oven or at room temperature for 24 h.

The electrical conductivity of the coating was measured using a four-point measuring device (RCHEK 4 Point Meter, manufacturer EDTM, model #RC2175). No electrical conductivity could be detected within the measuring range of the device (1-19990 Ohm/sq.). Measurements with a commercially available infrared camera (model: Flir One Pro from Flir) show a clear reflection of IR radiation in the wavelength range from 3 μm to 50 μm.

### Example 5: Coating of a Whitewashed or Coloured Wall Test Specimen

A formulation according to Example 1 with acrylate binder was prepared and tested qualitatively for homogeneity of the formulation. Both whitewashed and coloured wall test specimens were coated with the formulation using a brush or paint roller. Drying took place over approx. 24 hours at room temperature.

The colour of the coloured wall test specimens remained unchanged even after drying. Measurements with a commercially available infrared camera (model: Flir One Pro from Flir) show a clear reflection of IR radiation in the wavelength range from 3 um to 50 μη.

### Example 6: Coating of a Concrete Test Specimen

A formulation according to Example 1 with acrylate binder was prepared and tested qualitatively for homogeneity of the formulation. Test specimens of concrete were coated with the formulation using a brush or paint roller. Drying took place over approx. 24 hours at room temperature.

Measurements with a commercially available infrared camera (model: Flir One Pro from Flir) show a clear reflection of IR radiation in the wavelength range from 3 μm to 50 μm. FIG. 1 shows a corresponding measurement of the heat reflection in the comparison between an uncoated and a coated concrete test specimen. The significantly increased reflection of IR radiation in the case of the coated test specimen is clearly visible. When using a heat source with a temperature of 33° C., the measurement for the uncoated concrete body results in a temperature of 25.2° C., while the coated concrete body shows a temperature of 29.8° C.

### Example 7: Coating of a Plaster Test Specimen

A formulation according to Example 1 with acrylate binder was prepared and tested qualitatively for homogeneity of the formulation. Test specimens of plaster were coated with the formulation using a brush or paint roller. Drying took place over approx. 24 hours at room temperature.

Measurements with a commercially available infrared camera (model: Flir One Pro from Flir) show a clear reflection of IR radiation in the wavelength range from 3 μm to 50 μm. The electrical conductivity of the coating was measured using a four-point measuring device (RCHEK 4 Point Meter, manufacturer EDTM, model #RC2175). No electrical conductivity could be detected within the measuring range of the device (1-19990 Ohm/sq.).

### Example 8: Coating of a Wooden Test Specimen

A formulation according to Example 1 with acrylate binder was prepared and tested qualitatively for homogeneity of the formulation. Test specimens of wood were coated with the formulation using a brush or paint roller. Drying took place over approx. 24 hours at room temperature.

Measurements with a commercially available infrared camera (model: Flir One Pro from Flir) show a clear reflection of IR radiation in the wavelength range from 3 μm to 50 μm.

### Example 9: Coating of a Wallpaper

A formulation according to Example 1 with acrylate binder was prepared and tested qualitatively for homogeneity of the formulation. Both plain and patterned wallpaper pieces were coated with the formulation using a brush and a paint roller or using a transfer printing method. Drying took place over approx. 24 hours at room temperature or in an oven at 150° C. for 10 min.

Measurements with a commercially available infrared camera (model: Flir One Pro from Flir) show a clear reflection of IR radiation in the wavelength range from 3 μm to 50 μm. The electrical conductivity of the coating was measured using a four-point measuring device (RCHEK 4 Point Meter, manufacturer EDTM, model #RC2175). No electrical conductivity could be detected within the measuring range of the device (1-19990 Ohm/sq.).

### Example 10: Coating of Paper

A formulation according to Example 1 with acrylate binder was prepared and tested qualitatively for homogeneity of the formulation. Sheets of white paper were coated with the formulation using a brush. Drying took place at room temperature over approx. 24 h or in the oven at 120° C. for 5 min.

Measurements with a commercially available infrared camera (model: Flir One Pro from Flir) show a clear reflection of IR radiation in the wavelength range from 3 μm to 50 μm.

1. A formulation for producing an IR radiation-reflecting coating, wherein the formulation includes at least one electrically conductive metal nanomaterial, at least one binder and at least one solvent, wherein the weight ratio of electrically conductive metal nanomaterial to binder is greater than 0.005, and wherein the weight ratio of electrically conductive metal nanomaterial to binder is less than 2.

2. The formulation according to claim 1, characterized in that the weight ratio of electrically conductive metal nanomaterial to binder is greater than 0.05.

3. The formulation according to claim 1, characterized in that the weight ratio of electrically conductive metal nanomaterial to binder is less than 0.5.

4. The formulation according to claim 1, characterized in that the electrically conductive metal nanomaterial is comprises electrically conductive metal nanoparticles,

5. The formulation according to claim 1, characterized in that the formulation additionally contains electrically conductive carbon, electrically conductive carbon nanotubes, graphene, electrically conductive polymers, or mixtures thereof.

6. The formulation according to claim 1, characterized in that the formulation has one or more additives, wherein the additives comprise thickeners, adsorptive agents, wetting agents, fire retardants, polyvinylpyrrolidone, defoamers, foil formers, chemical stabilisers and colour pigments, wherein the colour pigments absorb predetermined proportions of the electromagnetic radiation in the wavelength range from 400 nm to 800 nm.

7. The formulation according to claim 1, characterized in that the binder comprises one or more of: acrylates, epoxies, polyurethanes, silicones, siloxanes, polyolefins, cellulose derivatives, polythiophenes, perfluorinated polymers and copolymers of said polymers and mixtures thereof.

8. The formulation according to claim 1, characterized in that the electrically conductive metal nanomaterial comprises electrically conductive metal nanowires, wherein a quotient of length and diameter of the metal nanowires is greater than 5.

9. A composite material comprising a substrate and an IR radiation-reflecting coating arranged on the substrate, wherein the coating is produced from a formulation for producing an IR radiation-reflecting coating, wherein the formulation includes at least one electrically conductive metal nanomaterial, at least one binder and at least one solvent, wherein the weight ratio of electrically conductive metal nanomaterial to binder is greater than 0.005, and wherein the weight ratio of electrically conductive metal nanomaterial to binder is less than 2.

10. The composite material according to claim 9, characterized in that the substrate is a polymer foil, a woven fabric, a knitted fabric, a textile material, glass, paper, concrete, cement, wood, plaster, plasterboard, a metal, or a plastic.

11. The composite material according to claim 9, characterized in that the coating has a dry layer thickness of not more than 60 μm,

12. The composite material according to claim 9, characterized in that the coating has an average spectral transmission of at least 30% in the wavelength range from 400 nm to 800 nm.

13. The composite material according to claim 9, characterized in that the coating has a reflectivity of more than 20% in the wavelength range from 3 μm to 50 μm.

14. The composite material according to claim 9, characterized in that the coating has no measurable electrical conductivity.

15. A method for producing a composite material, the method comprising the steps of:
a) providing a substrate,
b) providing a formulation for producing an IR radiation-reflecting coating, wherein the formulation includes at least one electrically conductive metal nanomaterial, at least one binder and at least one solvent, wherein the weight ratio of electrically conductive metal nanomaterial to binder is greater than 0.005, and wherein the weight ratio of electrically conductive metal nanomaterial to binder is less than 2,
c) applying the formulation prepared in step b) to the substrate provided in step a),
d) drying the object obtained in step c) to form a composite material consisting of a substrate and an IR radiation-reflecting coating arranged on the substrate.

16. The method according to claim 15, characterized in that the drying in step d) preferably takes place at a temperature T<200° C.

17. The method according to claim 15, characterized in that after step a) and before step c) the step of
pretreatment of the substrate surface is carried out by plasma pretreatment, corona pretreatment, cleaning, chemical pretreatment, or by applying a primer
is carried out, and in step c), the formulation provided in step b) is applied to the pretreated substrate.

18. The method according to claim 15, characterized in that in step c) the formulation provided in step b) is applied with spiral doctor blades, by screen printing, transfer printing, flow coating, spraying, or brushing.

19. The method according to claim 16, characterized in that in step c) the formulation provided in step b) is applied with spiral doctor blades, by screen printing, transfer printing, flow coating, spraying, or brushing.

20. The method according to claim 17, characterized in that in step c) the formulation provided in step b) is applied with spiral doctor blades, by screen printing, transfer printing, flow coating, spraying, or brushing.
